(19) United States
(12) Patent Application Publication
(10) Pub. No.: US 2013/0021288 A1
(43) Pub. Date: Jan. 24, 2013

(54) Apparatuses, Methods and Computer Programs for a Virtual Stylus

(71) Applicants: Leo Kärkkäinen, Helsinki (FI); Asta Kärkkäinen, Helsinki (FI); Antti Virolainen, Helsinki (FI)

(72) Inventors: Leo Kärkkäinen, Helsinki (FI); Asta Kärkkäinen, Helsinki (FI); Antti Virolainen, Helsinki (FI)

(73) Assignee: NOKIA CORPORATION, Espoo (FI)

(21) Appl. No.: 13/637,970

(22) PCT Filed: Mar. 31, 2010
(86) PCT No.: PCT/IB10/00728

§ 371 Date: Sep. 27, 2012

(51) Int. Cl. G06F 3/033; G06F 3/041

(52) U.S. Cl. 345/173; 345/179

(57) ABSTRACT

Apparatus, the apparatus configured to: receive depth motion signalling associated with depth motion actuation of a physical stylus; and generate image data of a virtual stylus which has a virtual length according to the received depth motion signalling.

### TECHNICAL FIELD

The present disclosure relates to the field of virtual reality, 2D/3D displays, 2D/3D touch interfaces, associated apparatus, methods and computer programs, and in particular concerns the creation of a virtual stylus based on motion signalling from a physical stylus. Certain disclosed aspects/embodiments relate to portable electronic devices, in particular, so-called hand-portable electronic devices which may be hand-held in use (although they may be placed in a cradle in use). Such hand-portable electronic devices include so-called Personal Digital Assistants (PDAs).

The portable electronic devices/apparatus according to one or more disclosed aspects/embodiments may provide one or more audio/text/video communication functions (e.g. tele-communication, video-communication, and/or text transmission, Short Message Service (SMS)/Multimedia Message Service (MMS)/emailing functions, interactive/non-interactive viewing functions (e.g. web-browsing, navigation, TV/program viewing functions), music recording/playing functions (e.g. MP3 or other format and/or (FM/AM) radio broadcast recording/playing), downloading/sending of data functions, image capture function (e.g. using a (e.g. in-built) digital camera), and gaming functions.

### BACKGROUND

Three-dimensional (3D) displays are used to create the illusion of depth in an image, and have recently gained significant interest. There has been an increase in the number of 3D movies being made, and a 3D television channel is due to be launched at some point this year. Although 3D technology is currently directed towards large screen displays, it is a matter of time before small screen displays are capable of presenting 3D images.

Touch screen personal digital assistants (PDAs), also known as palmtop computers, typically include a detachable stylus that can be used for interacting with the touch screen rather than using a finger. A stylus is often a pointed instrument with a fine tip, although this does not need to be the case. Interaction is achieved by tapping the screen to activate buttons or navigate menu options, and dragging the tip of the stylus across the screen to highlight text. A stylus may also be used for writing or drawing on the screen. The advantages of using a stylus are that it prevents the screen from being coated in natural oil from a user's finger, and improves the precision of the touch input, thereby allowing the use of smaller user interface elements.

Currently, styluses can only be used to interact with two-dimensional (2D) content on a 2D screen. How to interact with 3D content displayed on a 3D screen is therefore a consideration.

The apparatus and associated methods disclosed herein may or may not address this issue.

The listing or discussion of a prior-published document or any background in this specification should not necessarily be taken as an acknowledgement that the document or background is part of the state of the art or is common general knowledge. One or more aspects/embodiments of the present disclosure may or may not address one or more of the background issues.

### SUMMARY

According to a first aspect, there is provided apparatus, the apparatus configured to:
receive depth motion signalling associated with depth motion actuation of a physical stylus; and
generate image data of a virtual stylus which has a virtual length according to the received depth motion signalling.

The apparatus may be configured to further receive one or more of translational motion, rotational motion and angular motion signalling associated with respective translational, rotational and angular motion of a physical stylus. The apparatus may be configured to generate image data of a virtual stylus which has one or more of a virtual translational, rotational and angular orientation according to the received signalling.

The apparatus may be configured to generate image data of a virtual stylus on a virtual scene. The virtual scene may comprise one or more virtual items which can be manipulated by changes in motion signalling. The changes in motion signalling may comprise changes in one or more of depth motion, translational motion, rotational motion and angular motion signalling. Manipulation of the one or more virtual items may comprise one or more of the following: selecting, pushing, pulling, dragging, dropping, lifting, grasping and hooking one or more of the virtual items.

The apparatus may be further configured to receive viewing angle signalling associated with an observer viewing angle with respect to a display for the image data. The apparatus may be configured to generate corresponding image data of a virtual stylus on a virtual scene according to the received viewing angle signalling. The apparatus may be further configured to receive viewing angle signalling associated with an observer viewing angle with respect to the physical stylus. The apparatus may be configured to generate corresponding image data of a virtual stylus on a virtual scene according to the received viewing angle signalling. The apparatus may be configured to provide image data of a virtual scene according to the observer viewing angle. The apparatus may be configured to provide image data for displaying the virtual stylus and virtual scene as three-dimensional images.

The physical stylus may or may not be in physical contact with a display for the image data. The display may be a touch display comprising one or more of the following technologies: resistive, surface acoustic wave, capacitive, force panel, optical imaging, dispersive signal, acoustic pulse recognition and bidirectional screen technology.

The apparatus may comprise haptic technology configured to provide tactile feedback to a user of the physical stylus when the virtual stylus interacts with the virtual scene. The virtual scene may comprise two or more regions. Each region may be configured to interact differently with the virtual stylus. The haptic technology may be configured to provide different feedback in response to interaction of the virtual stylus with each of the different regions.

The apparatus may be selected from the list comprising a user interface, a two-dimensional display, a three-dimensional display, a processor for the user interface/two-dimensional display/three-dimensional display, and a module for the user interface/two-dimensional display/three-dimensional display. The processor may be a microprocessor, including an Application Specific Integrated Circuit (ASIC).

According to a further aspect, there is provided apparatus comprising a processor, the processor configured to:
receive depth motion signalling associated with depth motion actuation of a physical stylus; and
generate image data of a virtual stylus which has a virtual length according to the received depth motion signalling.

According to a further aspect, there is provided apparatus, the apparatus comprising:
a receiver configured to receive depth motion signalling associated with depth motion actuation of a physical stylus; and
a generator configured to generate image data of a virtual stylus which has a virtual length according to the received depth motion signalling.

According to a further aspect, there is provided apparatus, the apparatus configured to:
generate depth motion signalling associated with depth motion actuation of a physical stylus; and
provide the depth motion signalling to allow for generation of image data of a virtual stylus which has a virtual length according to the generated depth motion signalling.

The apparatus may be configured to generate depth motion signalling based on pressure applied to the physical stylus. The pressure may be radial pressure. The apparatus may be configured to generate depth motion signalling based on changes in length of the physical stylus. The depth motion signalling may be based on changes in telescopic length of the physical stylus.

The apparatus may be configured to further generate one or more of translational motion, rotational motion and angular motion signalling associated with respective translational, rotational and angular motion of a physical stylus. The apparatus may be configured to provide signalling for generation of image data of a virtual stylus which has one or more of a virtual translational, rotational and angular orientation according to the generated signalling.

The apparatus may be selected from the list comprising a stylus, a processor for a stylus, and a module for a stylus.

According to a further aspect, there is provided apparatus comprising a processor, the processor configured to:
generate depth motion signalling associated with depth motion actuation of a physical stylus; and
provide the depth motion signalling to allow for generation of image data of a virtual stylus which has a virtual length according to the generated depth motion signalling.

According to a further aspect, there is provided apparatus, the apparatus comprising:
a generator configured to generate depth motion signalling associated with depth motion actuation of a physical stylus; and
a provider configured to provide the depth motion signalling to allow for generation of image data of a virtual stylus which has a virtual length according to the generated depth motion signalling.

According to a further aspect, there is provided a method of processing data, the method comprising:
receiving depth motion signalling associated with depth motion actuation of a physical stylus; and
generating image data of a virtual stylus which has a virtual length according to the received depth motion signalling.

According to a further aspect, there is provided a method of processing data, the method comprising:
generating depth motion signalling associated with depth motion actuation of a physical stylus; and
providing the depth motion signalling to allow for generation of image data of a virtual stylus which has a virtual length according to the generated depth motion signalling.

According to a further aspect, there is provided a computer program recorded on a carrier, the computer program comprising computer code configured to operate an apparatus, wherein the computer program comprises:
code for receiving depth motion signalling associated with depth motion actuation of a physical stylus; and
code for generating image data of a virtual stylus which has a virtual length according to the received depth motion signalling.

According to a further aspect, there is provided a computer program recorded on a carrier, the computer program comprising computer code configured to operate an apparatus, wherein the computer program comprises:
code for generating depth motion signalling associated with depth motion of a physical stylus; and
code for providing the depth motion signalling to allow for generation of image data of a virtual stylus which has a virtual length according to the generated depth motion signalling.

The present disclosure includes one or more corresponding aspects, embodiments or features in isolation or in various combinations whether or not specifically stated (including claimed) in that combination or in isolation. Corresponding means for performing one or more of the discussed functions are also within the present disclosure.

Corresponding computer programs for implementing one or more of the methods disclosed are also within the present disclosure and encompassed by one or more of the described embodiments.

The above summary is intended to be merely exemplary and non-limiting.

### BRIEF DESCRIPTION OF THE FIGURES

A description is now given, by way of example only, with reference to the accompanying drawings, in which:

FIG. 1 illustrates schematically a physical stylus used for interaction with a display;

FIG. 2a illustrates schematically an apparatus for receiving signalling and generating image data;

FIG. 2b illustrates schematically an apparatus for generating and providing signalling;

FIG. 3a illustrates schematically the position of the physical stylus tip in the plane of the display;

FIG. 3b illustrates schematically the angle of the physical stylus with respect to the plane of the display;

FIG. 3c illustrates schematically the orientation of the physical stylus in the plane of the display;

FIG. 3d illustrates schematically the distance of each end of the physical stylus from the plane of the display;

FIG. 3e illustrates schematically the rotational angle of the stylus about its longitudinal axis;

FIG. 4a illustrates schematically a virtual stylus having a first length when the physical stylus is at a first distance from the plane of the display;

FIG. 4b illustrates schematically a virtual stylus having a second length when the physical stylus is at a second distance from the plane of the display;

FIG. 4c illustrates schematically a virtual stylus having a third length when the physical stylus is at a third distance from the plane of the display;

FIG. 5a illustrates schematically a telescopic stylus in an extended state;

FIG. 5b illustrates schematically the telescopic stylus in a retracted state when a longitudinal force has been applied;

FIG. 5c illustrates schematically the telescopic stylus back in the extended state when the longitudinal force has been removed;

FIG. 6a illustrates schematically a virtual stylus having a first length when the telescopic stylus is in the extended state;

FIG. 6b illustrates schematically a virtual stylus having a second length when a longitudinal force has been applied to the telescopic stylus;

FIG. 6c illustrates schematically a virtual stylus having a first length when the longitudinal force has been removed;

FIG. 7 illustrates schematically the manipulation of a virtual object within a virtual scene using a virtual stylus;

FIG. 8 illustrates schematically the interaction of a virtual stylus with two different regions of a virtual scene;

FIG. 9a illustrates schematically a virtual stylus with a regular end;

FIG. 9b illustrates schematically a virtual stylus with a hooked end;

FIG. 9c illustrates schematically a virtual stylus with a claw end;

FIG. 10a illustrates schematically how the viewing angle may be selected by rotating the display;

FIG. 10b illustrates schematically how the viewing angle may be selected by adjusting the position of an observer with respect to the display;

FIG. 11a illustrates schematically a three-dimensional display comprising a lenticular lens;

FIG. 11b illustrates schematically a three-dimensional display comprising a parallax barrier;

FIG. 12 illustrates schematically a method of processing data;

FIG. 13 illustrates schematically another method of processing data; and

FIG. 14 illustrates schematically a computer readable media providing a computer program.

### DESCRIPTION OF EXAMPLE ASPECTS/EMBODIMENTS

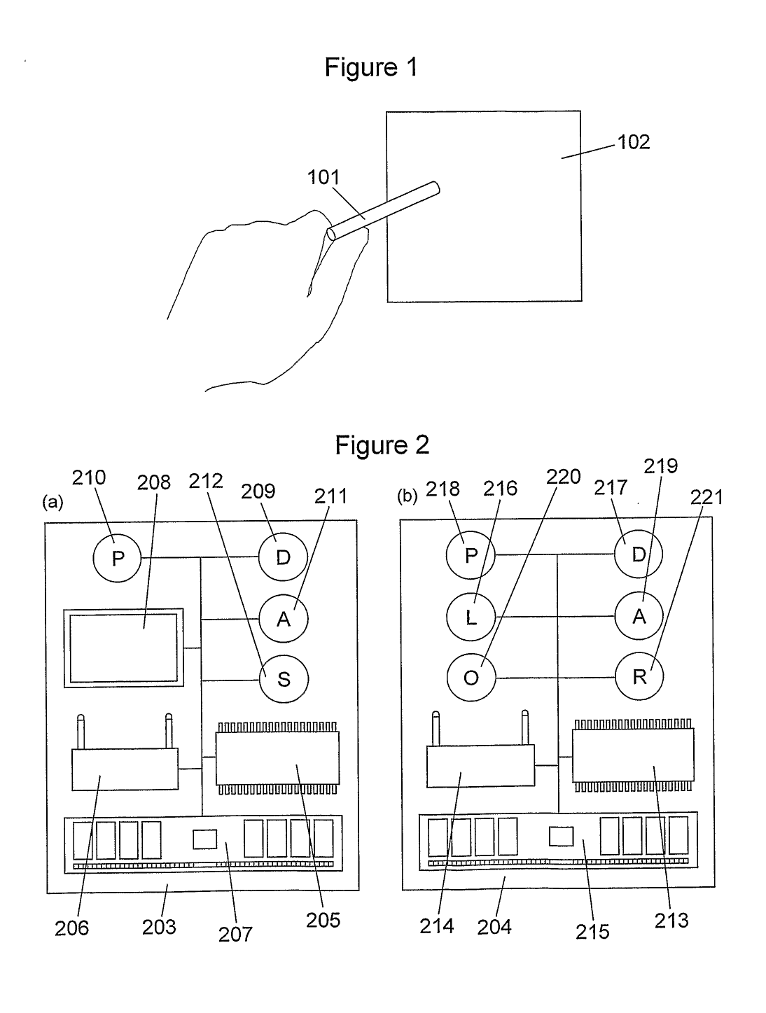

FIG. 1 illustrates schematically a stylus 101 used for interaction with a display 102. As discussed in the background section, styluses 101 can be used to interact with 2D content on a 2D display at present. There will now be described an apparatus and method which allows a user to interact with 3D content displayed on a 3D screen using a stylus (although other embodiments may relate to 3D content displayed on a 2D screen).

FIG. 2a illustrates schematically an apparatus 203 for receiving motion signalling and generating image data of a virtual stylus, whilst FIG. 2b illustrates schematically an apparatus 204 for generating and providing motion signalling. The apparatus 203 of FIG. 2a may comprise a receiver for receiving the motion signalling, and a generator for generating the image date. Likewise, the apparatus 204 of FIG. 2b may comprise a generator for generating the motion signalling, and a provider for providing the motion signalling. The key steps of the methods used to process data using the apparatus of FIGS. 2a and 2b are shown in FIGS. 12 and 13, respectively. The apparatus of FIG. 2a may be a display, a processor for a display, or a module for a display, whilst the apparatus of FIG. 2b may be a stylus, a processor for a stylus, or a module for a stylus. For simplicity in the text, however, the apparatus of FIG. 2a will be referred to herein as the “display”, and the apparatus of FIG. 2b will be referred to herein as the “physical stylus”. The display may comprise a screen for displaying 2D or 3D images to an observer. The physical stylus may take the form of a pointed instrument similar to that of a conventional PDA stylus.

As per a conventional stylus, the physical stylus must interact with the display in order to manipulate on-screen content. In the present case, the display is configured to generate a virtual (reality) stylus corresponding to the physical stylus, the virtual stylus mimicking the position and movement of the physical stylus. Advantageously, the display should update the image of the virtual stylus quickly enough that the delay between movement of the physical stylus and movement of the virtual stylus goes unnoticed by an observer of the display (or user of the physical stylus).

Unlike a conventional stylus, the physical stylus does not interact with the on-screen content directly. Instead, the virtual stylus interacts with the on-screen content. For this reason, the physical stylus need not be in physical contact with the display, although it may be. A key feature of certain embodiments of the apparatus and methods described herein is the ability to interact with on-screen items which are located at different depths within a 3D image. This is achieved by extending or retracting the length of the virtual stylus in response to depth motion of the physical stylus.

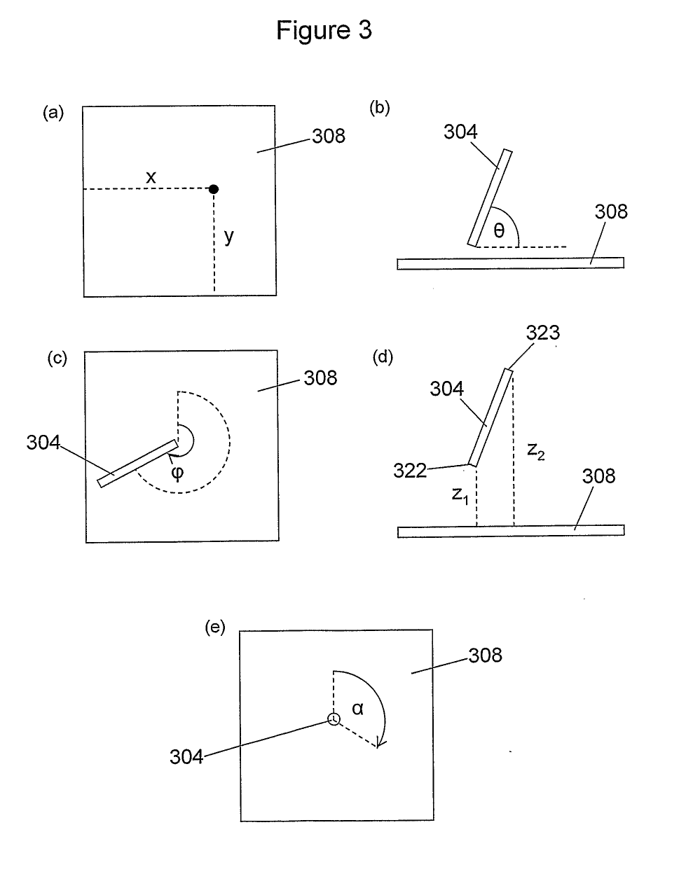

In order to generate the virtual stylus, a number of sensors are required. The sensors may be configured to detect: (i) the position (x,y) of the physical stylus tip in the plane of the display 308 (as illustrated in FIG. 3a), (ii) the angle (θ) of the physical stylus 304 with respect to the plane of the display 308 (as illustrated in FIG. 3b), (iii) the orientation (φ) of the physical stylus 304 in the plane of the display 308 (as illustrated in FIG. 3c), (iv) the distance (z) of the physical stylus 304 (possibly either end 322, 323 of the physical stylus 304) from the display 308 (as illustrates in FIG. 3d), (v) the rotational angle (α) of the physical stylus 304 about its longitudinal axis (as illustrated in FIG. 3e), which may be useful when the virtual stylus is a hook (see later), (vi) the length of the physical stylus 304, and (vii) the shape of the physical stylus 304. For simplicity in the text, the sensors used to determine (i) to (vii) will be referred to herein as the position sensor, angle sensor, orientation sensor, distance sensor, rotation sensor, length sensor, and shape sensor, respectively.

As shown in FIG. 2a, the display 203 comprises a processor 205, a transceiver 206, a storage medium 207, a display screen 208, a distance sensor 209, a position sensor 210, an angle sensor 211, and a shape sensor 212. Also, as shown in FIG. 2b, the physical stylus 204 comprises a processor 213, a transceiver 214, a storage medium 215, a length sensor 216, a distance sensor 217, a position sensor 218, an angle sensor 219, an orientation sensor 220, and a rotation sensor 221. Although the display 203 and the physical stylus 204 are each shown to comprise a position sensor 210, 218 and an angle sensor 211, 219, only one of each type of sensor are required per display/stylus pair. Furthermore, it should be noted that the infrared cameras (see below) of the physical stylus sensors 217-219 in this embodiment are configured to operate with the infrared LEDs of the display sensors 209-211.

With respect to the display 203, the distance sensor 209 may comprise infrared LEDs (to be used with a corresponding infrared camera as found in the Nintendo Wii™), or a laser transceiver (as found in laser speed guns); the position sensor 210 may comprise a camera, touch screen technology (which may be resistive, surface acoustic wave, capacitive, force panel, optical imaging, dispersive signal, acoustic pulse recognition, or bidirectional screen technology), or infrared LEDs; the angle sensor 211 may comprise infrared LEDs; and the shape sensor 212 may comprise a camera.

With respect to the physical stylus 204, the length sensor 216 may comprise a linear potentiometer or a piezoelectric sensor; the distance sensor 217 may comprise an infrared camera; the position sensor 218 may comprise an infrared camera; the angle sensor 219 may comprise an accelerometer, an infrared camera, or a gyroscope; the orientation sensor 220 may comprise an accelerometer or a gyroscope; and the rotation sensor 221 may comprise an optical encoder, a mechanical encoder, or a rotary potentiometer.

The skilled person will appreciate that many different types of sensor may be used to track the position and movement of the physical stylus 204, the technologies listed here constituting just some of the possible options. Given that the sensor technologies listed are well known in the art, the functional details of each sensor have not been described herein.

The processor 213 of the physical stylus 204 is configured to receive signalling generated by each stylus sensor 216-221 (or a single sensor that provides one or more type of position/motion signalling), and provide this signalling to the transceiver 214 for sending to the display 203. The processor 213 is also used for general operation of the physical stylus 204. In particular, the processor 213 provides signalling to, and receives signalling from, the other device components to manage their operation.

The transceiver 214 of the physical stylus 204 may be configured to transmit signalling from the physical stylus 204 to the display 203 over a wired or wireless connection. The wired connection may involve a data cable, whilst the wireless connection may involve Bluetooth™, infrared, a wireless local area network, a mobile telephone network, a satellite internet service, a worldwide interoperability for microwave access network, or any other type of wireless technology.

The storage medium 215 of the physical stylus 204 is configured to store computer code required to operate the apparatus, as described with reference to FIG. 14. The storage medium 215 may be a temporary storage medium such as a volatile random access memory, or a permanent storage medium such as a hard disk drive, a flash memory, or a non-volatile random access memory.

The transceiver 206 of the display 203 is configured to receive signalling from the physical stylus 204 over the wired or wireless connection.

The processor 205 of the display 203 is configured to receive signalling generated by each display and stylus sensor (signalling from the stylus sensors 216-221 provided via the display transceiver 206), and generate image data of a virtual stylus based on this signalling. The processor 205 is also used for general operation of the display 203. In particular, the processor 205 provides signalling to, and receives signalling from, the other device components to manage their operation.

The storage medium 207 of the display 203 is configured to store 2D or 3D image content for display, and is also configured to store computer code required to operate the apparatus, as described with reference to FIG. 14. The storage medium 207 may be a temporary storage medium such as a volatile random access memory, or a permanent storage medium such as a hard disk drive, a flash memory, or a non-volatile random access memory.

It is important to note that whilst each of the stylus and display sensors provide instantaneous position, length and angular measurements in these embodiments, they are configured to track the physical stylus 204 over time, thereby providing depth motion (z), translational motion (x,y), rotational motion (α) and angular motion (θ, φ) signalling. This allows the display processor 205 to generate up-to-date image data, resulting in a virtual stylus which accurately represents the physical stylus 204 at all times.

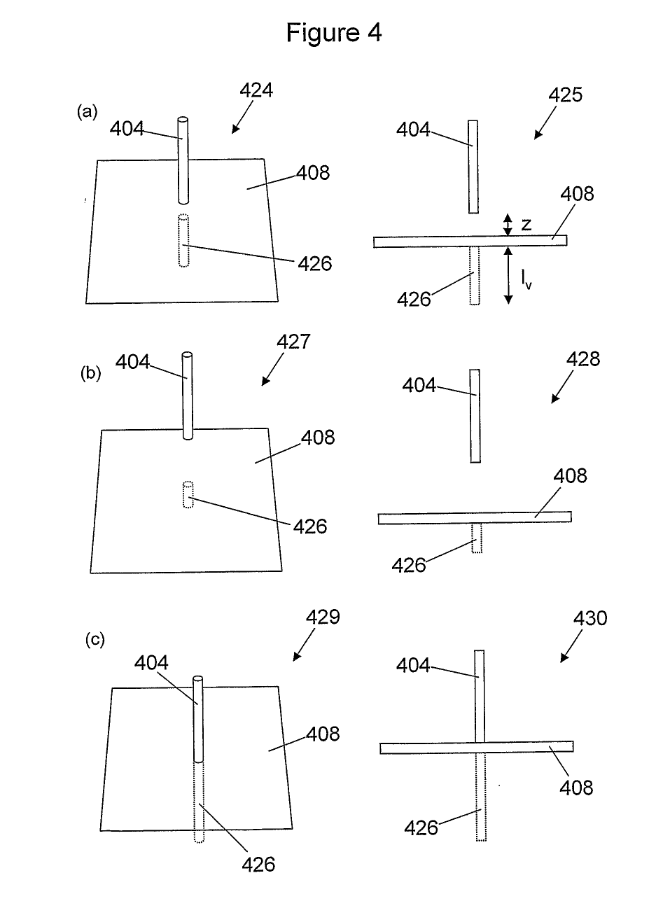

As mentioned previously, a key feature of the apparatus and methods described in these embodiments is the ability to interact with on-screen items which are located at different depths within a 3D image, which is achieved by extending or retracting the length of the virtual stylus in response to depth motion of the physical stylus. This is illustrated schematically in FIG. 4.

FIG. 4a shows (in both perspective 424 and cross-sectional 425 views) a virtual stylus 426 having a first length, Iᵥ, when the physical stylus 404 is at a first distance, z, from the plane of the display 408. In this embodiment, the physical stylus 404 need not be in physical contact with the display 408 (non-contact mode). The display 408 may be configured to show the virtual stylus 426 only when the physical stylus 404 gets to within a predetermined distance from the plane of the display 408. The general idea is to create the illusion of the physical stylus 404 extending from outside the display 408 to within the display 408.

Typically, the system would first be calibrated to align the virtual stylus 426 with the physical stylus 404 (x,y,z,α,θ,φ), and to set the screen boundaries with respect to the translational motion (x,y) of the physical stylus 404. If the system is not calibrated, the virtual stylus 426 will be unlikely to represent the physical stylus 404 accurately. As an example of miscalibration, the virtual stylus 426 may be oriented perpendicular to the plane of the display when the physical stylus 404 is oriented parallel to the plane of the display. This is clearly an extreme example, but even a slight miscalibration may be sufficient to detract from the faithfulness of the representation, and thereby ruin the virtual reality experience.

When the user moves the physical stylus 404 further from the display 408, the distance sensor detects a change in z (Δz), and signals the display 408 to update the image data. The display 408 responds by generating new image data, which appears on-screen as a retraction (ΔIᵥ) of the virtual stylus length (Iᵥ). In this way, as the user moves the physical stylus 404 away from the screen, the display creates the impression that the user is withdrawing the virtual stylus 426 from within the display 408 (i.e. decreasing the image depth to which the virtual stylus 426 extents). This is illustrated in FIG. 4b (in both perspective 427 and cross-sectional 428 views).

Likewise, when the user moves the physical stylus 404 closer to the display 408, the distance sensor detects a change in z (Δz), causing the display 408 to update the image data. This results in an extension (ΔIᵥ) of the virtual stylus length (Iᵥ). Therefore, as the user moves the physical stylus 404 towards the screen, the display 408 creates the impression that the user is pushing the virtual stylus 426 deeper into the display 408 (i.e. increasing the image depth to which the virtual stylus 426 extends). This is illustrated in FIG. 4c (in both perspective 429 and cross-sectional 430 views).

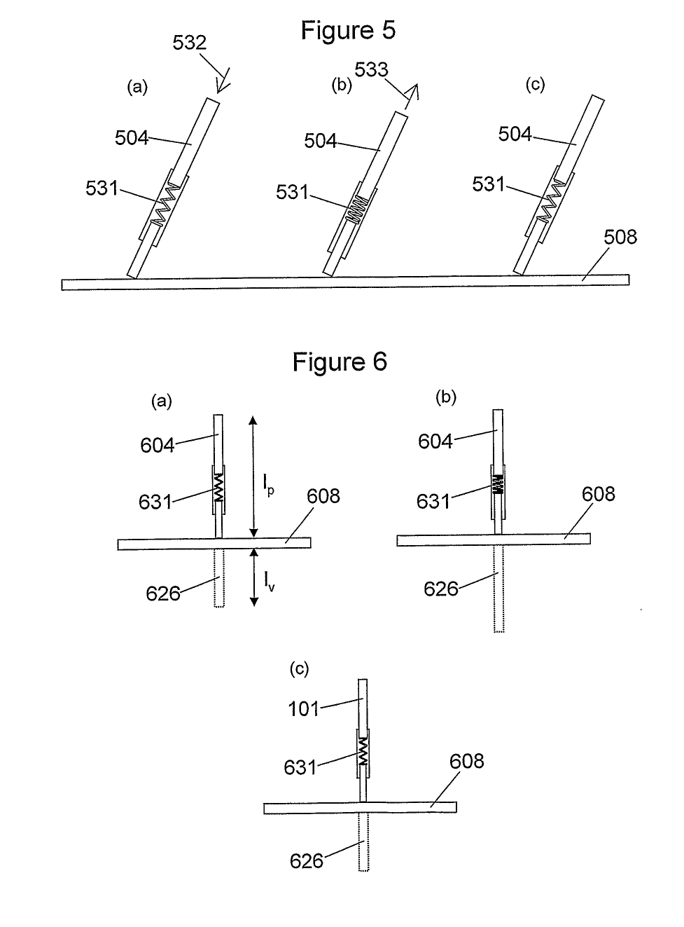

Another embodiment is illustrated in FIG. 5 in which physical contact is required between the physical stylus 504 and display 508 (contact mode). In this embodiment, the physical stylus 504 has a telescopic length (FIG. 5a). This feature (which may utilise a spring 531 or other apparatus allowing telescopic motion) allows the physical stylus 504 to retract (FIG. 5b) and extend (FIG. 5c) when a force 532, 533 is applied along the longitudinal axis of the physical stylus 504 towards and away from the display 508, respectively. Use of a telescopic stylus allows the user to maintain a substantially constant pressure on the screen of the display 508 whilst moving the physical stylus 504 towards or away from the screen. This is advantageous because it prevents the physical stylus from damaging the screen.

FIG. 6a shows (in cross-section) a virtual stylus 626 having a first length, Iᵥ, when the physical stylus 504 has a first length, Iₚ. The display 608 may be configured to show the virtual stylus 626 only when the physical stylus 604 is in physical contact with the display 608. In this embodiment, the degree of retraction or extension (ΔIₚ) is measured by the length sensor. When the user moves the physical stylus 604 closer to the display 608, the length sensor detects a change in Iₚ (ΔIₚ), causing the display 608 to update the image data. This results in an extension (ΔIᵥ) of the virtual stylus length (Iᵥ). Therefore, as the user moves the physical stylus 604 towards the screen, the display 608 creates the impression that the user is pushing the virtual stylus 626 deeper into the display 608 (i.e. increasing the image depth to which the virtual stylus 626 extends). This is illustrated in FIG. 6b (in cross-section).

When the user moves the physical stylus 604 further from the display 608, the distance sensor detects a change in Iₚ (ΔIₚ), and signals the display 608 to update the image data. The display 608 responds by generating new image data, which appears on-screen as a retraction (ΔIᵥ) of the virtual stylus length (Iᵥ). In this way, as the user moves the physical stylus 604 away from the screen, the display 608 creates the impression that the user is withdrawing the virtual stylus 626 from within the display 608 (i.e. decreasing the image depth to which the virtual stylus 626 extents). This is illustrated in FIG. 6c (in cross-section).

Another method for controlling the length of the virtual stylus in contact mode without the need for a telescopic stylus is by incorporating a pressure sensor into the shaft of the stylus (not shown). The pressure sensor may be configured to detect an applied pressure (or force) and convert this into a measurable signal which can be used to control the length of the virtual stylus. One example would be to incorporate a piezoelectric sensor into the physical stylus, the piezoelectric sensor configured to detect radial pressure. In this embodiment, the user could squeeze the physical stylus (i.e. apply a squeezing force perpendicular, i.e. radially, to the longitudinal axis of the stylus), and the sensor would convert the pressure to an electrical signal. This signal could then be sent to the display processor for generating image data. The virtual stylus would then undergo a change in length which is proportional to the applied pressure.

Another key feature of the apparatus and method described herein is the ability to interact with image content using the virtual stylus. For example, the display may be configured to present a virtual scene to the user. The virtual scene may comprise one or more virtual items. In one embodiment, the apparatus is configured to allow the virtual stylus to manipulate one or more of the virtual items. In this case, manipulation may comprise one or more of selecting, pushing, pulling, dragging, dropping, lifting, grasping and hooking the virtual items.

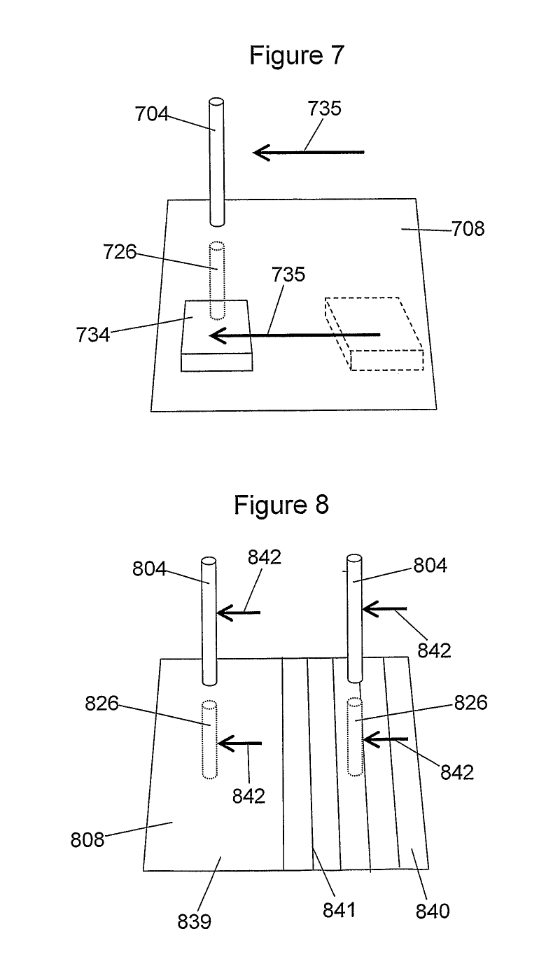

FIG. 7 illustrates schematically the manipulation of a virtual item 734 within a virtual scene using a virtual stylus 726. Here, the virtual stylus 726 is being used to move the virtual item 734 from one position in the virtual scene (image) to another position in the virtual scene (image). To achieve this, the user positions the physical stylus 704 sufficiently close to the display 708 (either within a predetermined distance of the display 708 in non-contact mode, as described with reference to FIG. 4, or in physical contact with the display 708 in contact mode, as described with reference to FIG. 6) such that the display 708 shows the virtual stylus 726 on-screen. Once the virtual stylus 726 is visible, the user then moves the physical stylus 704 until the virtual stylus 726 is in virtual contact with the virtual item 734. The user may then apply virtual pressure to the virtual item 734 by moving the physical stylus 704 closer to the display 708 (non-contact mode) or by applying pressure along the longitudinal axis of the physical stylus 704 towards the display 708 (contact mode). Once virtual pressure has been applied to the virtual item 734, the user can drag the virtual stylus 726 in a translational direction (x,y), as indicated by the arrows 735, by moving the physical stylus 704 in this direction (x,y) parallel to the display 708.

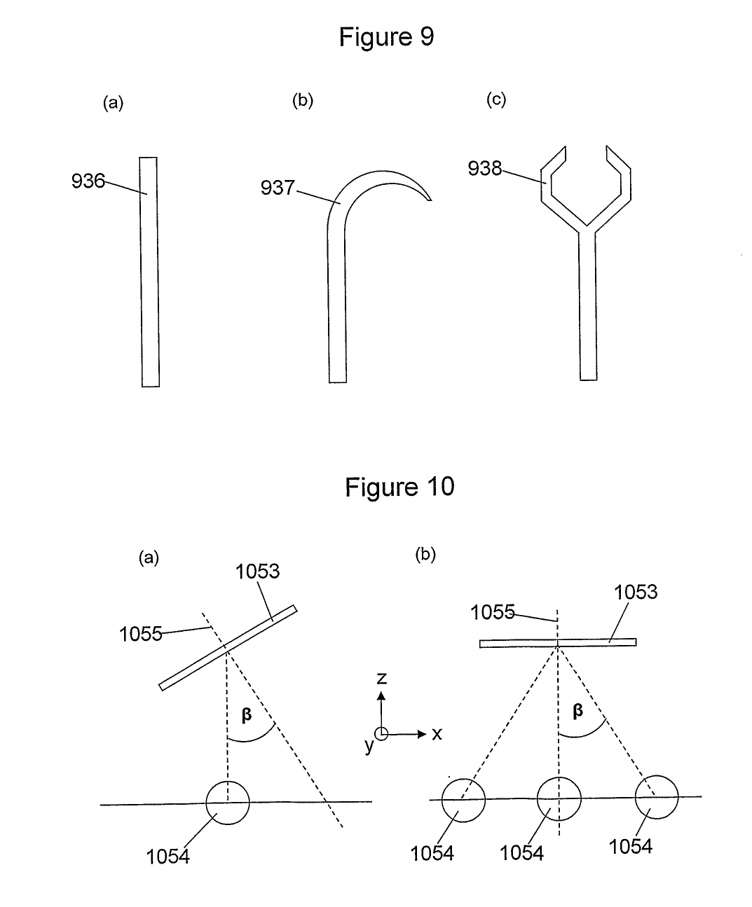

Whilst a regular shaped stylus 936 (FIG. 9a) may be used to manipulate virtual items, other shapes of virtual stylus may assist in this process. For example, although the application of pressure may be used to hold the virtual item in place while moving the item (as described above), movement of the virtual item may be more easily achieved using a virtual stylus with a hooked end 937 (FIG. 9b) to interact with a corresponding loop in the virtual item. Alternatively, the virtual stylus may benefit from having a claw end 938 (FIG. 9c) to grasp the virtual item. Various other end shapes may also be used to facilitate manipulation of the virtual item. To modify the shape of the virtual stylus, there is no need to modify the shape of the physical stylus (although this is also a possibility given that the display comprises a shape sensor). Instead, the display processor may be configured to generate image data to represent different shapes of stylus, regardless of the shape of the physical stylus. The user may then be able to select the shape that best suits the desired task.

The apparatus (either the display or physical stylus or both) may comprise haptic technology configured to provide tactile feedback to the user when the virtual stylus interacts with the virtual item. This feature would allow the user to “feel” the interaction. This type of technology is currently used in virtual reality systems, and may comprise one or more of pneumatic stimulation, vibro-tactile stimulation, electrotactile stimulation, and functional neuromuscular stimulation.

The skilled person will appreciate that many different types of haptic technology may be used to provide tactile feedback to the user, the technologies listed here constituting just some of the possible options. Given that the haptic technologies listed are well known in the art, the functional details of each technology have not been described herein.

The haptic technology may also be used to “feel” different textures within an image. For example, if the virtual scene comprises two or more regions, each region configured to interact differently with the virtual stylus, the haptic technology could be used to provide different tactile feedback in response to interaction of the virtual stylus with each of the different regions. This would therefore allow the user to distinguish between the different regions using touch rather than just sight alone, thereby further enhancing the virtual experience.

FIG. 8 illustrates schematically the interaction of a virtual stylus 826 with two different regions 839, 840 of a virtual scene. In this figure, one region 839 is smooth and the other region 840 comprises a periodic roughness 841. As the user moves the physical stylus 804 parallel to the plane of the display 808 in the direction shown by the arrows 842, the virtual stylus 826 is dragged across each region 839, 840. In this way, the user is be able to differentiate between the smooth region 839 and the rough region 840 based on the tactile feedback.

A further feature of the present apparatus is the ability to generate image data for the virtual stylus and virtual scene that corresponds to the perspective of the user. In real space (as opposed to virtual space), the appearance of size, shape, position, and even surface detail of an object vary depending on where the observer is located with respect to that object. Introducing this feature into the present system would therefore further enhance the virtual experience.

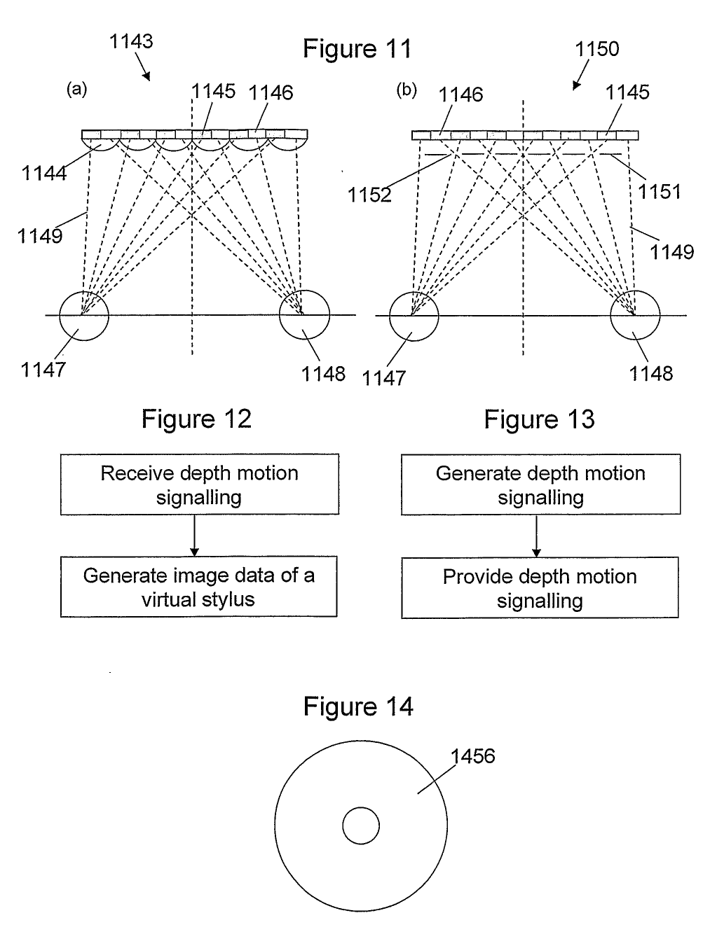

This can be achieved in two different ways depending on whether a 2D or 3D display screen is used. The illusion of depth is created by presenting an image of the same scene from a slightly different perspective to each of the observer's eyes. 3D displays typically use a lenticular lens (FIG. 11a) or a parallax barrier (FIG. 11b) to achieve this.

A lenticular lens display 1143 comprises an array of semi-cylindrical lenses 1144 which focus light 1149 from different columns of pixels 1145, 1146 at different angles. When an array of these lenses 1144 are arranged on a display 1143, images captured from different viewpoints 1147, 1148 can be made to become visible depending on the viewing angle. In this way, because each eye is viewing the lenticular lens display 1143 from its own angle, the screen creates an illusion of depth.

A parallax barrier display 1150 consists of a layer of material 1151 with a series of precision slits (holes) 1152. When a high-resolution display is placed behind the barrier, light 1149 from an individual pixel 1145, 1146 in the display 1150 is visible from a narrow range of viewing angles. As a result, the pixel 1145, 1146 seen through each hole 1152 differs with changes in viewing angle, allowing each eye to see a different set of pixels 1145, 1146, so creating a sense of depth through parallax.

Therefore, if the display comprises a lenticular lens or parallax barrier, images of the same scene from multiple viewing perpectives may be displayed at the same time. In this way, regardless of chosen viewing angle, the user of the physical stylus is able to observe an on-screen 3D image of the virtual scene and virtual stylus.

If, on the other hand, the display comprises a 2D screen (FIG. 10), a different approach is required because the screen 1053 is capable of displaying only one image at a time. In this scenario, the screen 1053 may be configured to display a different 2D image for each viewing angle, each 2D image showing the same scene from a different perspective. In effect, this technique may be used to create the illusion of a 3D image using a 2D display.

For this technique to work, the display 1053 requires apparatus to determine the position of the observer 1054 with respect to the plane of the screen. Two scenarios can be considered, one where the display 1053 is moved with respect to the observer 1054, as shown in FIG. 10a, and one where the observer 1054 moves relative to the display 1053, as shown in FIG. 10b. In the first scenario, the perspective of the observer 1054 may be selected by adjusting the orientation of the display 1053 with respect to the observer 1054 whilst keeping the position of the observer 1054 constant. The change in the display orientation may be detected using appropriate technology (position sensor), such as a camera located on the front of the display 1053. In the second scenario, the perspective of the observer 1054 may be selected by adjusting his position in the xy-plane with respect to the axis 1055 normal to the centre of the plane of the display 1053. The change in observer position may be determined using a camera (position sensor).

FIG. 14 illustrates schematically a computer/processor readable media 1456 providing a computer program for operating an apparatus, the apparatus configured to receive depth motion signalling associated with depth motion actuation of a physical stylus, and generate image data of a virtual stylus which has a virtual length according to the received depth motion signalling. In this example, the computer/processor readable media 1456 is a disc such as a digital versatile disc (DVD) or a compact disc (CD). In other embodiments, the computer readable media 1456 may be any media that has been programmed in such a way as to carry out an inventive function. The readable media 1456 may be a removable memory device such as a memory stick or memory card (SD, mini SD or micro SD).

The computer program may comprise code for receiving depth motion signalling associated with depth motion actuation of a physical stylus, and code for generating image data of a virtual stylus which has a virtual length according to the received depth motion signalling.

The computer/processor readable media 1456 may also provide a computer program for operating an apparatus, the apparatus configured to generate depth motion signalling associated with depth motion actuation of a physical stylus, and provide the depth motion signalling to allow for generation of image data of a virtual stylus which has a virtual length according to the generated depth motion signalling.

The computer program may also comprise code for generating depth motion signalling associated with depth motion of a physical stylus, and code for providing the depth motion signalling to allow for generation of image data of a virtual stylus which has a virtual length according to the generated depth motion signalling.

Other embodiments depicted in the figures have been provided with reference numerals that correspond to similar features of earlier described embodiments. For example, feature number 1 can also correspond to numbers 101, 201, 301 etc. These numbered features may appear in the figures but may not have been directly referred to within the description of these particular embodiments. These have still been provided in the figures to aid understanding of the further embodiments, particularly in relation to the features of similar earlier described embodiments.

It will be appreciated to the skilled reader that any mentioned apparatus, device, server or sensor and/or other features of particular mentioned apparatus, device, server or sensor may be provided by apparatus arranged such that they become configured to carry out the desired operations only when enabled, e.g. switched on, or the like. In such cases, they may not necessarily have the appropriate software loaded into the active memory in the non-enabled (e.g. switched off state) and only load the appropriate software in the enabled (e.g. on state). The apparatus may comprise hardware circuitry and/or firmware. The apparatus may comprise software loaded onto memory. Such software/computer programs may be recorded on the same memory/processor/functional units and/or on one or more memories/processors/functional units.

In some embodiments, a particular mentioned apparatus, device, server or sensor may be pre-programmed with the appropriate software to carry out desired operations, and wherein the appropriate software can be enabled for use by a user downloading a “key”, for example, to unlock/enable the software and its associated functionality. Advantages associated with such embodiments can include a reduced requirement to download data when further functionality is required for a device, and this can be useful in examples where a device is perceived to have sufficient capacity to store such pre-programmed software for functionality that may not be enabled by a user.

It will be appreciated that the any mentioned apparatus, circuitry, elements, processor or sensor may have other functions in addition to the mentioned functions, and that these functions may be performed by the same apparatus, circuitry, elements, processor or sensor. One or more disclosed aspects may encompass the electronic distribution of associated computer programs and computer programs (which may be source/transport encoded) recorded on an appropriate carrier (e.g. memory, signal).

It will be appreciated that any “computer” described herein can comprise a collection of one or more individual processors/processing elements that may or may not be located on the same circuit board, or the same region/position of a circuit board or even the same device. In some embodiments one or more of any mentioned processors may be distributed over a plurality of devices. The same or different processor/processing elements may perform one or more functions described herein.

It will be appreciated that the term “signalling” may refer to one or more signals transmitted as a series of transmitted and/or received signals. The series of signals may comprise one, two, three, four or even more individual signal components or distinct signals to make up said signalling. Some or all of these individual signals may be transmitted/received simultaneously, in sequence, and/or such that they temporally overlap one another.

With reference to any discussion of any mentioned computer and/or processor and memory (e.g. including ROM, CD-ROM etc), these may comprise a computer processor, Application Specific Integrated Circuit (ASIC), field-programmable gate array (FPGA), and/or other hardware components that have been programmed in such a way to carry out the inventive function.

The applicant hereby discloses in isolation each individual feature described herein and any combination of two or more such features, to the extent that such features or combinations are capable of being carried out based on the present specification as a whole, in the light of the common general knowledge of a person skilled in the art, irrespective of whether such features or combinations of features solve any problems disclosed herein, and without limitation to the scope of the claims. The applicant indicates that the disclosed aspects/embodiments may consist of any such individual feature or combination of features. In view of the foregoing description it will be evident to a person skilled in the art that various modifications may be made within the scope of the disclosure.

While there have been shown and described and pointed out fundamental novel features as applied to different embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment may be incorporated in any other disclosed or described or suggested form or embodiment as a general matter of design choice. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

1-30. (canceled)

31. An Apparatus configured to:
receive depth motion signalling associated with depth motion actuation of a physical stylus; and
generate image data of a virtual stylus which has a virtual length according to the received depth motion signalling.

32. The apparatus of claim 31, wherein the apparatus is configured to further receive one or more of translational motion, rotational motion and angular motion signalling associated with respective translational, rotational and angular motion of a physical stylus, and generate image data of a virtual stylus which has one or more of a virtual translational, rotational and angular orientation according to the received signalling.

33. The apparatus of claim 31, wherein the apparatus is configured to generate image data of a virtual stylus on a virtual scene, the virtual scene comprising one or more virtual items which can be manipulated by changes in motion signalling.

34. The apparatus of claim 33, wherein the changes in motion signalling comprise changes in one or more of depth motion, translational motion, rotational motion and angular motion signalling.

35. The apparatus of claim 33, wherein manipulation of the one or more virtual items comprises one or more of the following: selecting, pushing, pulling, dragging, dropping, lifting, grasping and hooking one or more of the virtual items.

36. The apparatus of claim 31, wherein the apparatus is further configured to receive viewing angle signalling associated with an observer viewing angle with respect to a display for the image data, and generate corresponding image data of a virtual stylus on a virtual scene according to the received viewing angle signalling.

37. The apparatus of claim 31, wherein the apparatus is further configured to receive viewing angle signalling associated with an observer viewing angle with respect to the physical stylus, and generate corresponding image data of a virtual stylus on a virtual scene according to the received viewing angle signalling.

38. The apparatus of claim 36, wherein the apparatus is configured to provide image data of a virtual scene according to the observer viewing angle.

39. The apparatus of claim 31, wherein the physical stylus is in physical contact with a display for the image data.

40. The apparatus of claim 39, wherein the display is a touch display comprising one or more of the following technologies: resistive, surface acoustic wave, capacitive, force panel, optical imaging, dispersive signal, acoustic pulse recognition and bidirectional screen technology.

41. The apparatus of any of claims 31 wherein the physical stylus is not in physical contact with a display for the image data.

42. The apparatus of claim 33, wherein the apparatus is configured to provide image data for displaying the virtual stylus and virtual scene as three-dimensional images.

43. The apparatus of any of claim 33, the apparatus comprising haptic technology configured to provide tactile feedback to a user of the physical stylus when the virtual stylus interacts with the virtual scene.

44. The apparatus of claim 43, wherein the virtual scene comprises two or more regions, each region configured to interact differently with the virtual stylus, the haptic technology configured to provide different feedback in response to interaction of the virtual stylus with each of the different regions.

45. The apparatus of claim 31, wherein the apparatus is selected from the list comprising a user interface, a two-dimensional display, a three-dimensional display, a processor for the user interface/two-dimensional display/three-dimensional display, and a module for the user interface/two-dimensional display/three-dimensional display.

46. An Apparatus configured to:
generate depth motion signalling associated with depth motion actuation of a physical stylus; and
provide the depth motion signalling to allow for generation of image data of a virtual stylus which has a virtual length according to the generated depth motion signalling.

47. The apparatus of claim 46, wherein the apparatus is configured to generate depth motion signalling based on pressure applied to the physical stylus.

48. The apparatus of claim 47, wherein the pressure is radial pressure.

49. The apparatus of claim 46, wherein the apparatus is configured to generate depth motion signalling based on changes in length of the physical stylus.

50. The apparatus of claim 49, wherein the depth motion signalling is based on changes in telescopic length of the physical stylus.
